(19) United States
(12) Patent Application Publication
(10) Pub. No.: US 2008/0110032 A1
(43) Pub. Date: May 15, 2008

(54) Carpentry tool

(76) Inventor: David L. Merritt, Moneta, VA (US)

Correspondence Address: Stephen G. Rudisill;NIXON PEABODY LLP, 48th Floor, 161 N. Clark Street, Chicago, IL, 60601, US

(21) Appl. No.: 11/983,887

(22) Filed: Nov. 13, 2007

Related U.S. Application Data
(60) Provisional application No. 60/858,782, filed on Nov. 14, 2006.

(51) Int. Cl. B26B 23/00

(52) U.S. Cl. 30/308.1; 144/373

(57) ABSTRACT

A carpentry tool comprises an elongated handle and a metal head attached to one end of the handle. The head includes a ferrule adapted to fit over one end of the handle, and first and second cutting portions extending laterally away from opposite sides of the ferrule. The first cutting portion has a width that progressively increases as the distance from the ferrule increases, and terminates in a first single cutting edge. The second cutting portion has a width that progressively decreases as the distance from the ferrule increases, and terminates in a second single cutting edge that is narrower than the first cutting edge.

### CROSS-REFERENCE TO RELATED APPLICATION

This application claims the benefit of U.S. Provisional Application No. 60/858,782, filed Nov. 14, 2006, which is hereby incorporated by reference in its entirety.

### FIELD OF THE INVENTION

This invention is directed generally to tools for use by carpenters and woodworkers and, more particularly, to a wood cutting tool that is particularly useful for builders of timber frames, log structures, restoration builders and boat builders.

### SUMMARY OF THE INVENTION

In one embodiment of the present invention, a carpentry tool comprises an elongated handle and a metal head attached to one end of the handle. The head includes a ferrule adapted to fit over one end of the handle, and first and second cutting portions extending laterally away from opposite sides of the ferrule. The first cutting portion has a width that progressively increases as the distance from the ferrule increases, and terminates in a first single cutting edge. The second cutting portion has a width that progressively decreases as the distance from the ferrule increases, and terminates in a second single cutting edge that is narrower than the first cutting edge.

Another aspect of the invention provides a method of

### BRIEF DESCRIPTION OF THE DRAWINGS

The invention may best be understood by reference to the following description taken in conjunction with the accompanying drawings, in which:

FIG. 1 is a side elevation of a carpentry toll implementing one embodiment of the invention; and

FIG. 2 is a top plan view of the tool shown in FIG. 1.

### DETAILED DESCRIPTION OF THE ILLUSTRATED EMBODIMENT

Although the invention will be described in connection with certain preferred embodiments, it will be understood that the invention is not limited to those particular embodiments. On the contrary, the invention is intended to include all alternatives, modifications and equivalent arrangements as may be included within the spirit and scope of the invention as defined by the appended claims.

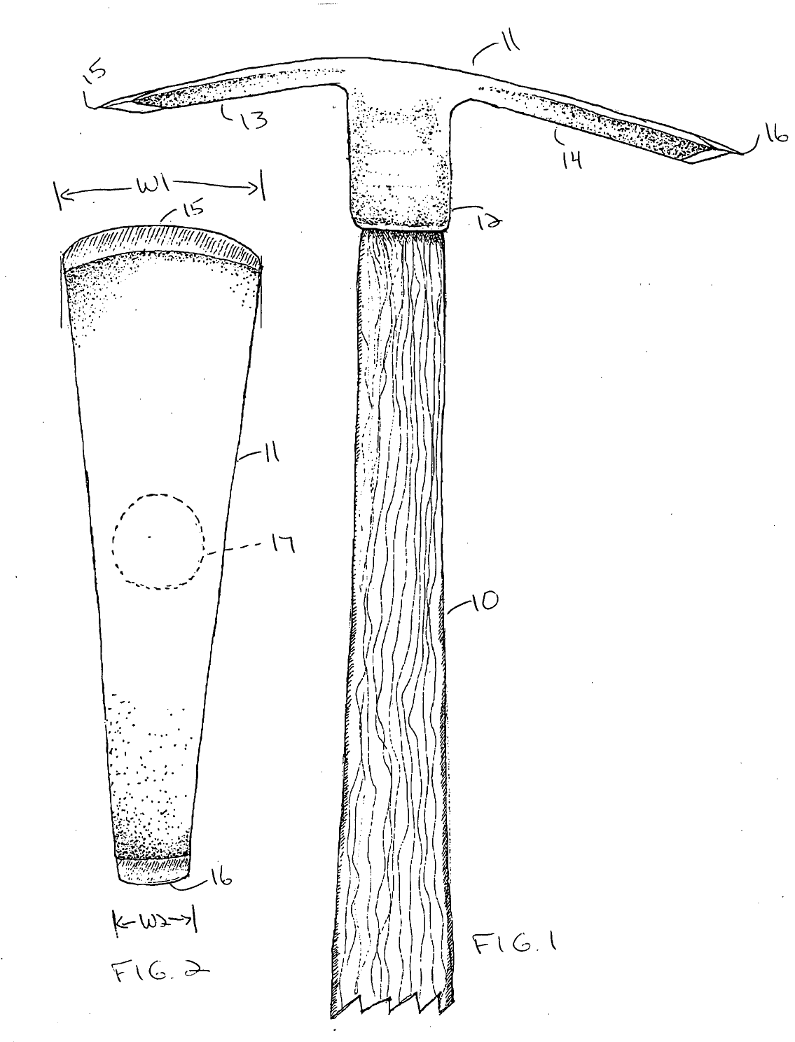

Referring now to the drawings, and initially to FIG. 1, the illustrative carpentry tool includes an elongated handle 10 having a metal head 11 attached to one end thereof. The head 11 has a ferrule 12 shaped and dimensioned to fit over one end of the handle 10, and first and second cutting portions 13 and 14 extending laterally away from opposite sides of the ferrule 12. The first cutting portion 13 has a width W1 that progressively increases as the distance from the ferrule 12 increases, and terminates in a first cutting edge 15. The second cutting portion 14 has a width that progressively decreases as the distance from the ferrule 12 increases, and terminating in a second cutting edge 16 that is narrower than the first cutting edge 15. Thus, the maximum width of the width of the head 11 is at the first cutting edge 15, and the minimum width of the head 11 is at the second cutting edge 16, with the width of the head 11 reducing progressively from the first cutting edge 15 to the second cutting edge 16. The two cutting edges 15 and 16 are formed by beveling at least the lower surfaces of the head adjacent the cutting edges. The angle of the bevel is preferably within a range from about 8 degrees to about 10 degrees for the wide cutting edge 15, and from about 10 degrees to about 12 degrees for the narrow cutting edge 16. As can be seen from the top plan view in FIG. 2, each of the cutting edges 15 and 16 is arcuate, forming a portion of a circle having its center coincident with the axis of the handle, and then tapering off more sharply at the ends of the cutting edges.

Both of the cutting portions 13 and 14 arc slightly toward the butt end of the handle.

In the illustrative embodiment, the lower end of the ferrule 12 forms a cavity 17 for receiving the upper end of the handle 10, and the upper end of the cavity 17 is closed. In an alternative embodiment, the cavity formed by the ferrule is open at both the upper and lower ends, to allow the upper end of the handle 10 to pass through the entire length of the ferrule 12. The handle 10 may be made from straight-grained hickory wood for shock absorption, although fiberglass is an optional handle material. The handle 10 is attached firmly to the head 11 by wedge and/or apoxy.

The head 11 is preferably made of moderately high carbon steel for ease of sharpening and good edge retention, i.e., “holding an edge.” The width of the head 11 reduces progressively from the wide cutting edge 15 to the narrow cutting edge 16, so that the maximum width is at the cutting edge 15 and the minimum width is at the cutting edge 16. The first cutting portion 13 preferably has a width W1 between about 1.75 and about 2.25 inches, and the second cutting portion 14 preferably has a width W2 that is less than about one inch, to provide a wide cutting range. Each of the two cutting portions 13 and 14 extends at least two inches from the ferrule 12, and the first cutting portion 13 preferably extends at least 2.5 inches from the ferrule 12. The length of the narrower cutting portion 14 allows the blade 16 to reach into relatively small, tight spaces. Both cutting portions 13 and 14 have a thickness within a range from about ⅛ inch to about ¼ inch. The cutting portions 13 and 14 arc slightly toward the butt end of the handle 10.

Each of the cutting edges 15 and 16 is arcuate (see FIG. 2), forming a portion of a circle having its center coincident with the axis of the handles, with rounded corners 15a, 15b and 16a, 16b at the opposite ends of the two cutting edges. The rounded corners prevent the blades from digging into the wood and becoming hung up. Both cutting edges are formed by beveling at least the lower surface of the head, preferably at an angle within a range from about 8 degrees to about 10 degrees for the cutting edge 15, and within a range from about 10 degrees to about 12 degrees for the cutting edge 16. The upper surface of the head may also be beveled, as in the illustrative embodiment, preferable at an angle of less than about 10 degree for both cutting edges.

In one embodiment, the entire head 11 shown in FIGS. 1 and 2 is approximately 12 inches long from the top of the head 11 to the butt end of the handle 10. The head is approximately 6.5 inches long with a moderate sweep, the first cutting edge has a width W1 of about 2 inches, and the second cutting edge has a width W2 of about 0.75 inches. The first cutting portion 13 extends about 2.5 inches laterally away from the ferrule 12, along a plane that intersects the axis of the handle 10 at an angle of about 100 degrees. The second cutting portion extends 2.25 inches laterally away from the ferrule 12, along a plane that intersects the axis of the handle 10 at an angle of about 105 degrees. This “sweep” of the cutting blades 15 and 16 enables them to cut efficiently because they attack the wood fibers at an angle, and the larger cutting angle of the narrower portion 14 enables the narrower blade 16 to more efficiently cut “stab” wood.

The illustrative tool is useful in many woodworking disciplines, including general carpentry, log building, timber framing, restoration carpentry, boat building, rustic furniture construction and other disciplines where wood needs to be cut, shaped or removed quickly. The tool is used to repeatedly strike an area of wood to be removed from a workpiece of wood. In many applications this tool permits tasks to be completed quickly and accurately with a single tool and a one-handed operation, instead of using a chisel (which takes two hands), jig saw, reciprocating saw, slick or other tools. The tool can be securely carried in a carpenter's extra belt loop so that it is readily available for use at any time. When used in conjunction with a shingling hatchet, the tool can shape, cut, taper and split wooden shakes with ease. The one-handed operation is particularly significant when working on a steeply pitched roof or scaffolding.

The Tool was designed to be truly general purpose so variations in the design would be limited, although several size variations may be possible. It would be feasible to produce two sizes and accompany the appropriate size hammer with each, perhaps a Rough Carpentry Tool and a Finish Carpentry Tool with 28 oz. and 21 oz. hammers respectively.

While particular embodiments and applications of the present invention have been illustrated and described, it is to be understood that the invention is not limited to the precise construction and operation disclosed herein and that various modifications, changes, and variations may be apparent from the foregoing descriptions without departing from the spirit and scope of the invention as defined in the appended claims.

1. A carpentry tool comprising
an elongated handle and a metal head attached to one end of said handle, said head having a ferrule adapted to fit over one end of said handle, and first and second cutting portions extending laterally away from opposite sides of said ferrule,
said first cutting portion having a width that progressively increases as the distance from said ferrule increases, and terminating in a first single cutting edge, and
said second cutting portion having a width that progressively decreases as the distance from said ferrule increases, and terminating in a second single cutting edge that is narrower than said first cutting edge.

2. The carpentry tool of claim 1 in which said first and second cutting portions arc slightly toward the butt end of said handle.

3. The carpentry tool of claim 1 in which the maximum width of said head is at said first cutting edge, the minimum width of said width of said head is at said second cutting edge, and the width of said head reduces progressively from said first cutting edge to said second cutting edge.

4. The carpentry tool of claim 1 in which said cutting edges are formed by beveling at least the lower surfaces of said head.

5. The carpentry tool of claim 4 in which the angle of said beveling of said lower surfaces is within a range from about 8 degrees to about 10 degrees for said first cutting edge.

6. The carpentry tool of claim 4 in which the angle of said beveling of said lower surfaces is within a range from about 10 degrees to about 12 degrees for said second cutting edge.

7. The carpentry tool of claim 4 in which said cutting edges are formed by beveling both the upper and lower surfaces of said head, and the angle of said beveling of said upper surfaces is within a range from zero degrees to about 10 degrees for both of said first and second cutting edges.

8. The carpentry tool of claim 1 in which each of said cutting edges is arcuate, forming a portion of a circle having its center coincident with the axis of said handle.

9. The carpentry tool of claim 1 in which the opposite ends of each of said cutting edges are rounded.

10. The carpentry tool of claim 1 in which the width of said second cutting edge is less than one inch.

11. The carpentry tool of claim 1 in which the width of said first cutting edge is between about 1.75 inches and about 2.25 inches.

12. The carpentry tool of claim 1 in which the plane of said first cutting portion intersects the axis of said handle at an angle of about 100 degrees.

13. The carpentry tool of claim 1 in which the plane of said second cutting portion intersects the axis of said handle at an angle of about 105 degrees.

14. The carpentry tool of claim 1 in which the length of each of said first and second cutting portions is at least two inches from said ferrule.

15. The carpentry tool of claim 1 in which the length of said first cutting portions is at least 2.5 inches from said ferrule.

16. The carpentry tool of claim 1 in which the thickness of each of said first and second cutting portions is within a range from about ⅛ inch to about ¼ inch.

17. A method of manually cutting a workpiece of wood with a hand tool, comprising
repeatedly striking an area of wood to be removed from said workpiece with a cutting edge formed on a metal head attached to one end of a handle and having first and second cutting portions extending laterally away from opposite sides of said handle, said first cutting portion having a width that progressively increases as the distance from said handle increases and terminates in a first single cutting edge, and said second cutting portion having a width that progressively decreases as the distance from said handle increases and terminates in a second single cutting edge that is narrower than said first cutting edge.
